(19) United States
(12) Patent Application Publication
(10) Pub. No.: US 2008/0305014 A1
(43) Pub. Date: Dec. 11, 2008

(54) SUBSTRATE PROCESSING APPARATUS

(75) Inventor: Koichi Honda, Toyama-shi (JP)

Correspondence Address: MATTINGLY, STANGER, MALUR & BRUNDIDGE, P.C., 1800 DIAGONAL ROAD, SUITE 370, ALEXANDRIA, VA, 22314, US

(73) Assignee: Hitachi Kokusai Electric Inc.

(21) Appl. No.: 12/132,606

(22) Filed: Jun. 3, 2008

(30) Foreign Application Priority Data
Jun. 7, 2007 (JP) JP2007-151605
May 14, 2008 (JP) JP2008-126721

(51) Int. Cl. G05D 7/00

(52) U.S. Cl. 422/111

(57) ABSTRACT

A substrate processing apparatus which stably supplies a vaporized gas of liquid raw material to a processing chamber includes liquid raw material tanks storing a liquid raw material, a carrier gas supply line supplying a carrier gas to one of the tanks, a raw material supply line pressure-feeding to this tank the liquid raw material of the other tank, a carrier gas supply line feeding a carrier gas to the tank, a raw material supply line feeding to the processing chamber a vaporized gas of the liquid raw material of the tank, a mass flow controller which controls the flow rate of the carrier gas, a mass flow controller detecting the flow rate of the vaporized gas of the liquid raw material, and a feedback device feeding back a detection result of the mass flow controller to the former mass flow controller.

### INCORPORATION BY REFERENCE

The present application claims priorities from Japanese applications JP2007-151605 filed on Jun. 7, 2007 and JP2008-126721, filed on May 14, 2008, the contents of which are hereby incorporated by reference into this application.

### BACKGROUND OF THE INVENTION

This invention relates to substrate processing apparatuses and, in particular, to a substrate processing apparatus for processing a substrate by use of a vaporized gas of liquid raw material.

As one example of this type of substrate processing apparatus, there is known an apparatus which employs the so-called bubbling technique for supplying a carrier gas to a liquid raw material tank which stores a liquid raw material to thereby feed a vaporized gas of the liquid raw material to a processing chamber. In this apparatus, the feed amount of the vaporized gas of liquid raw material to the processing chamber is controlled, in some cases, by the feed rate of a carrier gas being supplied to the liquid raw material tank. In particular, the feed rate of such carrier gas is sometimes controlled by a detection result of a temperature of the liquid raw material, which is obtained by a temperature sensor that is provided in the liquid raw material tank.

### SUMMARY OF THE INVENTION

In this case, it is possible to control the feed rate of the carrier gas; however, it is impossible to recognize the actual feed rate of the evaporated gas of the liquid raw material. Thus, the above-stated apparatus still fails to directly control the feed rate of the evaporated gas of liquid raw material; so, it remains difficult to stabilize the feed rate of the evaporated gas of liquid raw material supplied to the processing chamber. For this reason, even when the supply of the evaporated gas of liquid raw material becomes unstable in state due to some sort of causes (such as pipe clogging due to a residual by-product material), it is no longer possible to detect such state. This can cause the evaporated gas to be liquefied again or “reliquefied” within the pipe in which the evaporated gas is flowing, resulting in production of contaminant particles. These particles often badly behave to block or “choke” not only the pipe but also a gas supply nozzle or the like, which is provided within the processing chamber.

On the other hand, a temperature sensor (sensing module) which detects a temperature of the liquid raw material is fixedly installed at a prespecified position of the liquid raw material tank.

When its liquid surface is varied (reduced) in accordance with the use amount of the liquid raw material, it is impossible to accurately detect the temperature of the liquid surface of the liquid raw material. At this time, even when an attempt is made to accurately control the feed rate of the carrier gas, it is not possible to increase its accuracy. Thus, it becomes difficult to stabilize the feed rate of the evaporated gas of liquid raw material to the processing chamber also, resulting in the lack of an ability to improve uniformity of the thickness of a film to be formed on the substrate.

A primary object of this invention is to provide a substrate processing apparatus capable of stabilizing the supply of an evaporated gas of liquid raw material to the processing chamber.

According to this invention, a substrate processing apparatus is provided, which comprises: a processing chamber for processing a substrate; a heating unit for heating the substrate; an evacuation unit for removing an atmospheric gas or gases within said processing chamber; a couple of first and second liquid raw material tanks each containing therein a liquid raw material; a first carrier gas supply line for supplying a first carrier gas to the first liquid raw material tank; a first raw material supply line for receiving supply of the first carrier gas to said first liquid raw material tank and for sending by pressure the liquid raw material of said first liquid raw material tank toward the second liquid raw material tank; a second carrier gas supply line for supplying a second carrier gas to the second liquid raw material tank; a second raw material supply line for receiving supply of the second carrier gas to said second liquid raw material tank and for supplying a vaporized gas of the liquid raw material of said second liquid raw material tank to said processing chamber; a flow rate control device for controlling a flow rate of the second carrier gas flowing in said second carrier gas supply line; a flow rate detection device for detecting a flow rate of the vaporized gas flowing in said second raw material supply line; and a feedback device for feeding back a detection result of said flow rate detection device to said flow rate control device, wherein said second liquid raw material tank is smaller in internal volume than said first liquid raw material tank and wherein said second liquid raw material tank reserves said liquid raw material required for a one time of processing (i.e., for a single processing).

According to this invention, the feedback device is arranged to feed back the detection result of the detector device to the flow rate control device. Thus, it is possible to recognize the actual feed amount of the evaporated gas of the liquid raw material. It is also possible to precisely control the feed rate of the inactive gas without relation to variations of a liquid surface of the liquid raw materials in the first and second liquid raw material tanks. This makes it possible to stabilize the feed rate of the evaporated gas of liquid raw material to the processing chamber. Therefore, it is possible to suppress unwanted production of particles otherwise occurring due to reliquefaction of the evaporated gas of liquid raw material and flow blockage or “clogging” at a gas feed nozzle which is provided within the processing chamber and also possible to improve uniformity of the thickness of a film to be formed on the substrate.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a perspective view of an overall structure of a substrate processing apparatus in accordance with one preferred embodiment of this invention.

FIG. 2 is a diagram showing a longitudinal sectional view of a vertical-standing processing furnace used in the preferred embodiment of this invention along with its associative members for showing schematically configurations thereof.

FIG. 3 is a diagram showing schematically a configuration of a raw gas supply source in accordance with one preferred embodiment of this invention.

FIG. 4 is a block diagram showing a schematical circuit configuration of the raw gas supply source in accordance with one preferred embodiment of this invention.

FIG. 5 is a diagram showing schematically an arrangement of a comparative example of the raw gas supply source of FIG. 3.

FIG. 6 is a block diagram showing feedback control in a controller.

FIG. 7 is a schematic configuration diagram of a raw gas supply source in accordance with another preferred embodiment of the invention.

### DETAILED DESCRIPTION OF THE EMBODIMENTS

Currently preferred embodiments of this invention will new be described in detail with reference to the accompanying drawings below.

A substrate processing apparatus in accordance with this embodiment is the one that is configured as one example of a semiconductor device fabrication apparatus for use in the manufacture of semiconductor integrated circuit (IC) devices. In the description below, there will be stated the case where a vertical type apparatus which applies thermal processing or the like to a substrate is used as one example of the substrate processing apparatus.

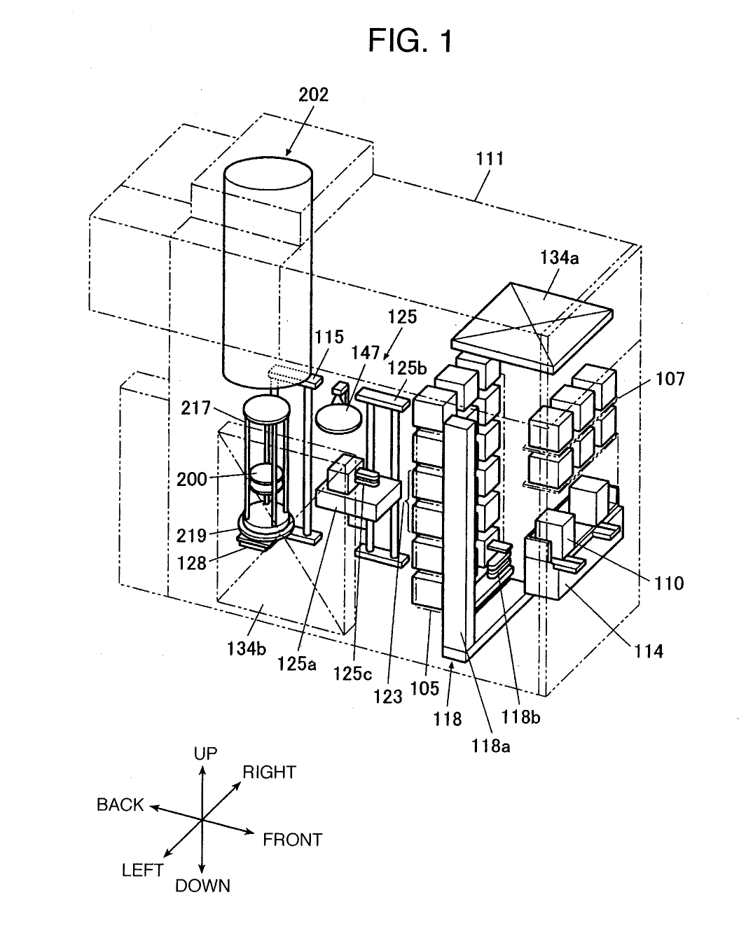

As shown in FIG. 1, in a substrate processing apparatus 101, a cassette 110 is used, which contains wafers 200, each of which becomes one example of the substrate. The wafers 200 are made of a silicon material or the like. The substrate processing apparatus 101 has a housing 111, with a cassette stage 114 being installed therein. The cassette 110 is arranged to be delivered and loaded onto the cassette stage 114 by an in-factory transfer device (not shown) and unloaded from the cassette stage 114 by such device.

The cassette stage 114 is mounted by the in-factory transfer device in such a manner that the wafers 200 in the cassette 110 hold a vertical posture and that a wafer inlet/outlet port of the cassette 110 turns up. The cassette stage 114 is arranged to become operative to rotate clockwise the cassette 110 by an angle of 90 degrees along the vertical direction toward the rear end part of the housing 111, thereby causing the wafers 200 in the cassette 110 to become the horizontal posture, resulting in the wafer in/out port of the cassette 110 facing the rear end of the housing 111.

At an almost central portion in a forward/backward direction within the housing 111, a cassette rack 105 is provided. The cassette rack 105 is arranged to have a plurality of stages and a plurality of columns for storage of a plurality of cassettes 110. In the cassette rack 105, transfer shelves 123 are provided, each of which is for placing a cassette 110 that becomes a delivery object of a wafer transport mechanism 125.

Above the cassette stage 114, spare cassette shelves 107 are provided, which are arranged to hold cassettes 110 as spare stocks.

A cassette delivery device 118 is provided between the cassette stage 114 and the cassette rack 105. The cassette delivery device 118 is made up of a cassette elevator 118a capable of going up and down while holding a cassette 110, and a cassette delivery mechanism 118b which serves as a transportation mechanism. The cassette delivery device 118 is arranged to convey the cassette 110 between any two of the cassette stage 114 and the cassette rack 105 plus the spare cassette rack 107 owing to continuous operations of the cassette elevator 118a and cassette delivery mechanism 118b.

A wafer transfer mechanism 125 is installed behind the cassette rack 105. This wafer transfer mechanism 125 is made up of a wafer load/unload device 125a capable of rotating a wafer 200 in the horizontal direction and/or moving it straightly and a wafer load/unload device elevator 125b for elevation of the wafer load/unload device 125a. The wafer load/unload device 125a is provided with a tweezer 125c for pickup of a wafer 200. The wafer load/unload device 125 is arranged to load (charge) a wafer 200 into a boat 217 and unload (discharge) it from the boat 217, with the tweezer 125c being as a mount part of the wafer 200, owing to continuous operations of the wafer load/unload device 125a and the wafer load/unload device elevator 125b.

At an upper rear part of the housing 111, a processing furnace 202 is provided for applying thermal processing to the wafer 200, wherein a low end part of this processing furnace 202 is designed to be opened and closed by a furnace hole shutter 147.

Below the processing furnace 202, a boat elevator 115 is provided for causing the boat 217 to go up and down relative to the processing furnace 202. An arm 128 is coupled to an elevator table of the boat elevator 115. This arm 128 has a seal cap 219 which is horizontally fixed thereto. The seal cap 219 is arranged to support the boat 217 vertically while at the same time making it possible to block the low end part of the processing furnace 202.

The boat 217 has a plurality of holding members, which are arranged to horizontally hold a plurality of (e.g., 50 to 150) wafers 200 respectively in the state that the wafers 200 are arrayed in the vertical direction, with their centers being aligned together.

Above the cassette rack 105, a clean unit 134a is installed for supplying clean air, which is a cleaned atmosphere. The clean unit 134a is constructed from a supply fan and a dust-proof filter and arranged to cause the clean air to flow in the interior space of the housing 111.

At a left-side end of the housing 111, a clean unit 134b is provided for supplying clean air. The clean unit 134b also is structured from a supply fan and a dustproof filter and is arranged to force the clean air to flow near or around the wafer load/unload device 125a and boat 217 or the like. This clean air is externally exhausted from the housing 111 after it has flown around the wafer load/unload device 125a and boat 217 and so on.

An explanation will next be given of a principal operation of the substrate processing apparatus 101.

When a cassette 110 is conveyed by the in-factory delivery (carrier) device (not shown) onto the cassette stage 114, the cassette 110 is situated in such a way that wafers 200 hold the vertical posture on the cassette stage 114 and that the wafer in/out port of the cassette 110 turns up. Thereafter, the cassette 110 is driven by the cassette stage 114 to perform clockwise rotation by an angle of 90 degrees about an axis in the vertical direction to the rear part of the housing 111 in such a manner that the wafers 200 in the cassette 110 become the horizontal posture and the wafer in/out port of the cassette 110 is directed to the rear part of the housing 111.

Thereafter, the cassette 110 is automatically conveyed by the cassette delivery device 118 for delivery to a designated shelf position of either the cassette rack 105 or the spare cassette rack 107 and temporarily stored thereat; after such temporal storage, the cassette 110 is transferred by the cassette delivery device 118 from either the cassette rack 105 or the spare cassette rack 107 to one of the transfer shelves 123 or, alternatively, sent directly to the transfer shelf 123.

When the cassette 110 is transferred to and situated on the transfer shelf 123, one of the wafers 200 is picked up by the tweezer 125c of wafer load/unload device 125a from the cassette 110 through its wafer in/out port and is then charged to the boat 217. The wafer load/unload device 125a that has delivered the wafer 200 to the boat 217 returns to the cassette 110 and then charges a following wafer 110 to this boat 217.

After a prespecified number of wafers 200 are charged to the boat 217, the furnace hole shutter which has closed the lower end part of the processing furnace 202 opens, resulting in the lower end of processing furnace 202 being released. Thereafter, the boat 217 that holds a group of wafers 200 is loaded into the processing furnace 202 owing to an elevation operation of the boat elevator 115; then, the lower part of the processing furnace 202 is closed by the seal cap 219.

After completion of the loading, given thermal processing is applied to the wafers 200 in the processing furnace 202. After having performed the thermal processing, the wafers 200 and the cassette 110 are taken out or “discharged” to the outside of the housing 111 in a procedure reverse in order to the above-stated process.

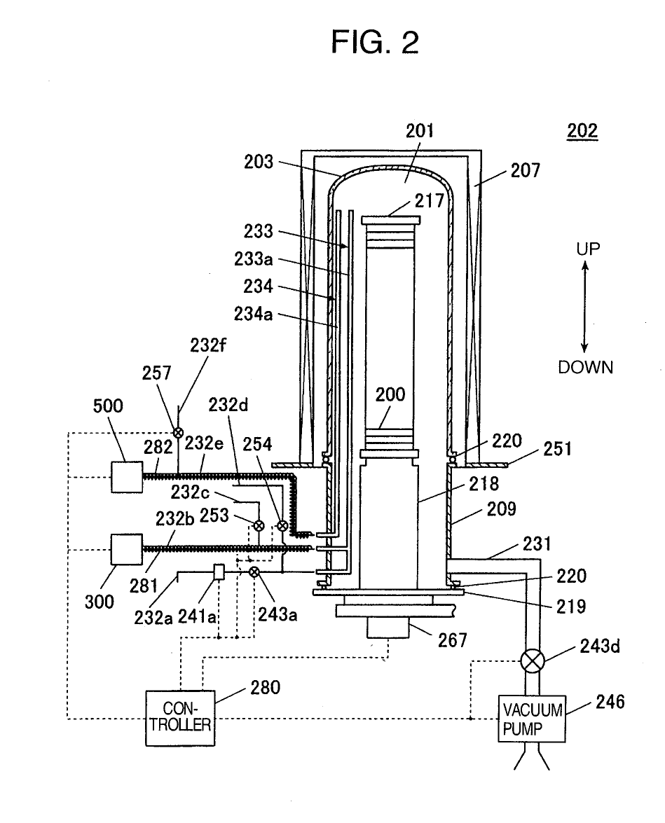

As shown in FIG. 2, the processing furnace 202 is provided with a heater 207 which is a heating device. On the inner side of this heater 207, a reaction pipe 203 is provided as a reaction vessel or barrel, which processes a wafer 200 that is a substrate. At a lower end of the reaction pipe 203, a manifold 209 (annular flange), which is made of stainless steel as an example, is engaged via an O-ring 220. The manifold 209 is fixed to a heater base 251 which is for use as a supporting member. A lower opening of the manifold 209 is air-tightly blocked by the seal cap 219, which is a lid body, by way of the O-ring 220. In this embodiment, the processing furnace 202 is formed by at least the heater 207, reaction pipe 203, manifold 209 and seal cap 219. Further in this embodiment, a processing chamber 201 is formed by at least the reaction pipe 203, manifold 209 and seal cap 219.

At the seal cap 219, the boat 217 is provided via a boat support table 218 in a stand-up fashion. The boat support table 218 is a holder which holds the boat 217. The boat 217 is inserted into the processing chamber 201. On the boat 217, a plurality of wafers 200 to be subjected to batch processing are carried at multiple stages in the up-down direction of FIG. 2 in the state that these wafers retain the horizontal posture. The heater 207 is arranged to heat a wafer 200 which is inserted into the processing chamber 201 up to a predetermined temperature.

Three separate raw gas supply pipes 232a, 232b and 232e are provided for supplying a plurality of kinds (in this embodiment, three kinds) of raw material gases to the processing chamber 201. The raw gas supply pipes 232a, 232b, 232e are provided to penetrate lower part of the manifold 209. The raw gas supply pipe 232a and the raw gas supply pipe 232b are communicatively combined together at a single multi-hole nozzle 233a within the processing chamber 201. The two raw gas supply pipes 232a and 232b and the multi-hole nozzle 233a constitute a confluence type gas supply nozzle 233, which will be described later.

The raw gas supply pipe 232e is solely coupled to another multi-hole nozzle 234a. The single raw gas supply pipe 232e and the multi-hole nozzle 234a form a separation type gas supply nozzle 234 to be later described. Within the processing chamber 201, two gas supply nozzles are provided, i.e., the confluence type gas supply nozzle 233 and the separation type gas supply nozzle 234.

The confluence type gas supply nozzle 233 has its upper part which extends in a region within the processing chamber 201, which region has its temperature that is more than or equal to a decomposition temperature of TMA to be supplied from the raw gas supply pipe 232b. However, a portion at which the raw gas supply pipe 232b is joined to the raw gas supply pipe 232a within the processing chamber 201 is a region with its temperature being less than the decomposition temperature of TMA, and is a region with its temperature being lower than a temperature of wafer 200 per se and temperatures at nearby places of the wafer 200.

The raw gas supply pipe 232a is provided with a mass flow controller 241a that is a flow rate control means and a valve 243a which is an open/close valve. In this embodiment, via the mass flow controller 241a and valve 243a, a raw gas (O₃) is supplied from the raw gas supply pipe 232a to the processing chamber 201 through the confluence type gas supply nozzle 233. By the valve 243a of raw gas supply pipe 232a, an inactive gas feed pipe 232d is connected on the downstream side, with a valve 254 being provided at the inactive gas feed pipe 232d.

Coupled to the raw gas supply pipe 232b is a raw gas supply source 300 which becomes a supply source of a raw gas. In this embodiment, a raw gas (TMA) is supplied from the raw gas supply source 300 to the processing chamber 201 through the confluence type gas supply nozzle 233. The raw gas supply pipe 232b is provided with a heater 281, which covers from (a mass flow controller 344 of) the raw gas supply source 300 up to the manifold 209 for causing the raw gas supply pipe 232b to be maintained at a temperature of 50 to 60° C. In this embodiment, a known ribbon heater with a heater wire being assembled in glass cloth is used as the heater 281, wherein this ribbon heater is wound around the raw gas supply pipe 232b. An inactive gas feed pipe 232c is coupled to the raw gas supply pipe 232b, and the inactive gas feed pipe 232c is provided with a valve 253.

A raw gas supply source 500 that becomes a supply source of a raw gas is coupled to the raw gas supply pipe 232e. In this embodiment, a raw gas (TEMAH) is fed from the raw gas supply source 500 to the processing chamber 201 through the separation type gas supply nozzle 234. The raw gas supply pipe 232e is provided with a heater 282 which covers from (a mass flow controller 544 of) the raw gas supply source 500 up to the manifold 209 and which keeps the raw gas supply pipe 232e at 130° C. In this embodiment, a ribbon heater is used as the heater 282 in a similar way to the heater 281, wherein this ribbon heater 282 is wound around the raw gas supply pipe 232e. An inactive gas feed pipe 232f is coupled to the raw gas supply pipe 232e. The inactive gas feed pipe 232f is provided with a valve 257.

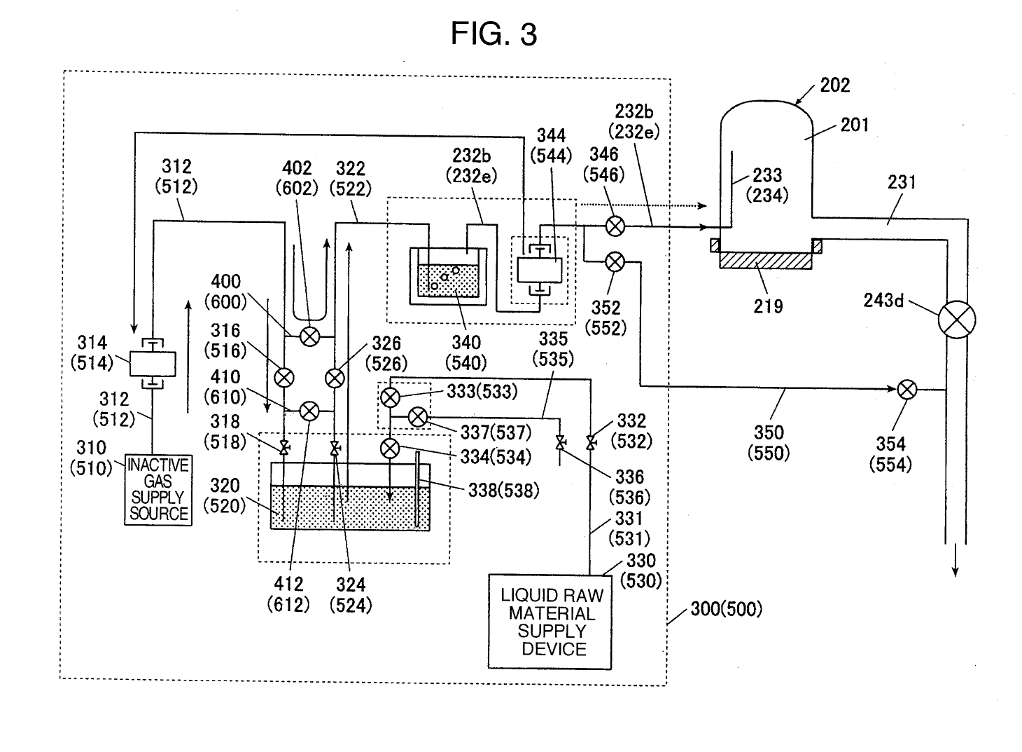

As shown in FIG. 3, the raw gas supply source 300 is provided with an inactive gas supply source 310 which becomes a supply source of an inactive gas for use as a carrier gas, a liquid raw material tank 320 which contains therein a liquid raw material, a liquid raw material supply device 330 which supplies the liquid raw material to the liquid raw material tank 320, and a liquid raw material tank 340 which receives the supply of the liquid raw material from the liquid raw material tank 320 and reserves it for later use.

To the inactive gas supply source 310, one end portion of an inactive gas feed pipe 312 is connected; the other end of the inactive gas feed pipe 312 is coupled to the liquid raw material tank 320. The other end of the inactive gas feed pipe 312 is dipped in the liquid raw material of the liquid raw material tank 320. At the inactive gas feed pipe 312, there are provided a mass flow controller 314 which controls the flow rate of an inactive gas, a valve 316 and a hand valve 318.

One end of a liquid raw material supply pipe 322 is connected to the inactive gas supply source 320; the other end of the liquid raw material supply pipe 322 is coupled to the liquid raw material tank 340. The one end of the liquid raw material supply pipe 322 is dipped in the liquid raw material of the liquid raw material tank 320. The other end of the liquid raw material supply pipe 322 is also dipped in the liquid raw material of the liquid raw material tank 340. The liquid raw material supply pipe 322 is provided with a hand valve 324 and a valve 326.

Between the inactive gas feed pipe 312 and the liquid raw material supply pipe 322, two bypass tubes 400 and 410 are provided for coupling these pipes together. The bypass tube 400 has one end which is connected between the mass flow controller 314 of inactive gas feed pipe 312 and the valve 316 and the other end which is coupled between the hand valve 324 of liquid raw material supply pipe 322 and the valve 326. The bypass tube 400 is provided with a valve 402. The bypass tube 410 has one end which is connected between the valve 316 and hand valve 318 of the inactive gas feed pipe 312 and the other end which is coupled between the hand valve 324 and valve 326 of liquid raw material supply pipe 322. The bypass tube 410 is provided with a valve 412.

To the liquid raw material supply device 330, a liquid raw material supply pipe 331 is coupled at its one end. The liquid raw material supply pipe 331 is coupled at its other end to the liquid raw material tank 320. The liquid raw material supply pipe 331 is provided with a hand valve 332 and valves 333-334. An inactive gas feed pipe 335 is coupled between the valve 333 and valve 334 of the inactive gas feed pipe 331. The inactive gas feed pipe 335 is provided with a hand valve 336 and a valve 337.

The liquid raw material tank 320 is provided with a residual quantity monitoring sensor 338 is provided, which monitors a residual amount of the liquid raw material. The raw gas supply source 300 is arranged so that the liquid raw material is automatically supplied from the liquid raw material supply device 330 to the liquid raw material tank 320 based on a detection result of the residual amount monitor sensor 338, thereby causing a constant amount of liquid raw material to be reserved in the liquid raw material tank 320 at all times.

The liquid raw material tank 340 is less in internal volume than the liquid raw material tank 320 and becomes smaller in liquid raw material storage amount than the liquid raw material tank 320. More specifically, the liquid raw material tank 340 is designed to reserve a certain amount of liquid raw material which is required for execution of a one time of batch processing.

The raw gas supply pipes 232b is connected at its one end to the liquid raw material tank 340. The other end of the raw gas supply pipes 232b is coupled to the multi-hole nozzle 233a. The one end of raw gas supply pipe 232b is gas-flowably coupled to the upper space of the liquid raw material tank 340 (but not dipped in the liquid raw material). The raw gas supply pipe 232b is provided with a mass flow controller 344 and a valve 346. The mass flow controller 344 is a heatable mass flow meter which has a flow rate sensor with enhanced thermal durability and a piezoelectric valve or the like and which is arranged to have capabilities of detecting and controlling the flow rate of a vaporized gas of the liquid raw material flowing in the raw gas supply pipe 232b and also heating such vaporized gas.

A raw gas exhaust pipe 350 is connected between the mass flow controller 344 and the valve 346 of the raw gas supply pipe 232b. The raw gas exhaust pipe 350 is provided with valves 352 and 354.

On the other hand, in the raw gas supply source 500 also, it has a similar arrangement to that of the raw gas supply source 300. In this embodiment, bracketed reference numerals are added to such respective members in FIG. 3, with explanations thereof being omitted herein.

It should be noted that in the above-stated raw gas supply sources 300 and 500, TMA (Al(CH₃)₃, trimethylaluminum) is used as one example of the liquid raw material in the raw gas supply source 300 whereas TEMAH (Hf[NCH₃C₂H₅]₄, tetrakis(N-ethyl-N-ethylamino) hafnium) is used as one example of the liquid raw material in the raw gas supply source 500. Both TMA and TEMAH are liquids at a room temperature.

As shown in FIG. 2, a gas exhaust pipe 231 is coupled to the processing chamber 201 for exhausting gases therein. A valve 243d is provided at the gas exhaust pipe 231. The gas exhaust pipe 231 is coupled via the valve 243d to a vacuum pump 246 which is an evacuation device. By activation of the vacuum pump 246, an inside atmosphere of the processing chamber 201 is exhausted for vacuum evacuation thereof. The valve 243d is an open/close valve capable of performing and stopping the vacuum evacuation of the processing chamber 201 through open and close operations of the valve while enabling pressure adjustment by control of the open degree of such valve.

The confluence type gas supply nozzle 233 and the separation type gas supply nozzle 234 are placed to extend along the mount direction of the wafers 200 while covering from lower part to upper part of the processing chamber 201. As previously stated, the confluence type gas supply nozzle 233 is the nozzle that is gas-flowably coupled to the single multi-hole nozzle 233a as a result of the raw gas supply pipes 232a and 232b being combined together at the lower part of the processing chamber 201.

The separation type gas supply nozzle 234 is an independent nozzle with the raw gas supply pipe 232e being communicatively coupled to the single multi-hole nozzle 234a. At the multi-hole nozzle 233a of the confluence type gas supply nozzle 233, a plurality of gas feed holes are provided for supplying a plurality of gases. At the multi-hole nozzle 234a of the separation type gas supply nozzle 234 also, gas feed holes are provided to feed gases.

At a central portion within the reaction pipe 203, a boat 217 is provided for mounting and holding a plurality of wafers 200 at equal intervals in a multi-stage fashion. The boat 217 is arranged to enter to and exit from the reaction pipe 203 with the aid of the boat elevator 115 (see FIG. 1). Additionally, below the boat support table 218, a boat rotation mechanism 267 is provided for rotating the boat 217 in order to improve the uniformity of processing. In this embodiment, it is possible by rotation of the boat rotation mechanism 267 to rotate the boat 217 which is held on the boat support table 218.

A controller 280 which is a control unit (control means) is connected to the mass flow controller 241a, valve 243a, valves 253, 254, 257, valves 243d, heater 207, vacuum pump 246, boat rotation mechanism 267, boat elevator 115, heaters 281, 282 and others. In this embodiment, the controller 280 performs control operations including, but not limited to, flow rate adjustment of the mass flow controller 241a, open/close operations of the valve 243a and valves 253, 254, 257, open/close and pressure adjustment operations of the valve 243d, temperature adjustment of the heater 207, activation/deactivation of the vacuum pump 246, rotation speed adjustment of the boat rotation mechanism 267, rising/falling operations of the boat elevator 115, and temperature adjustment of the heaters 281, 282.

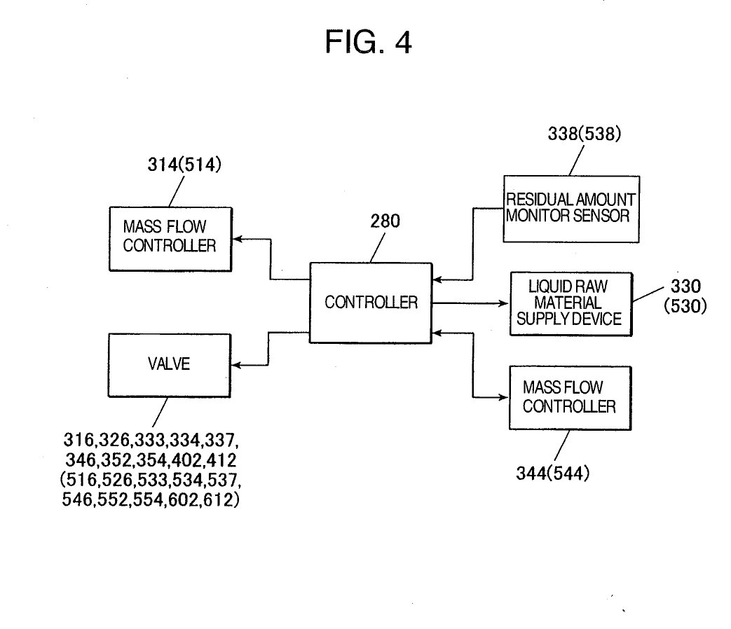

Furthermore, the controller 280 is also connected to the raw gas supply source 300. More precisely, as shown in FIG. 4, the controller 280 is connected to the mass flow controller 314, valves 316, 326, 333, 334, 337, 346, 352, 354, 402, 412, liquid raw material supply device 330, residual amount monitor sensor 338, and mass flow controller 344. In this embodiment, the controller 280 performs controls in terms of flow rate adjustment of the mass flow controller 314, open/close operations of the valves 316, 326, 333, 334, 337, 346, 352, 354, 402, 412, start/stop of the liquid raw material supply device 330 in response to receipt of a detection result of the residual amount monitor sensor 338, and flow rate adjustment of the mass flow controller 344. Additionally, the controller 280 is also connected to respective members of the raw gas supply source 500, wherein control of each member of the raw gas supply source 500 is performed in a similar way to the control for the raw gas supply source 300.

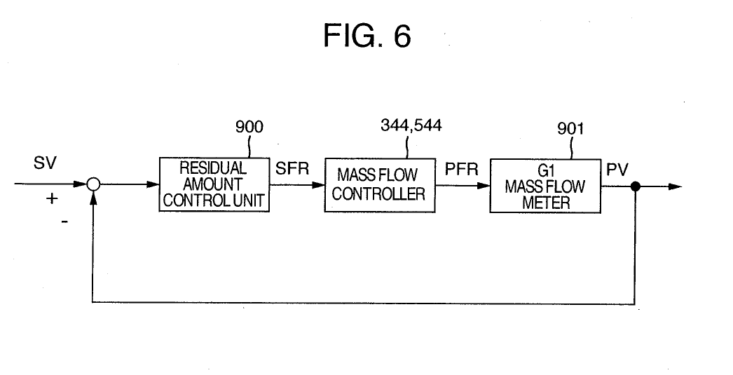

Note here that the controller 280 monitors the feed rate of a vaporized gas of the liquid raw material by means of the mass flow controllers 344, 544 and performs feedback of a detection result thereof. More practically, in FIG. 6, the controller 280 inputs a setup flow rate SV of the mass flow controller 344, 544 to a flow rate control unit 900. Next, the flow rate control unit 900 sends forth a setup output aimed at the mass flow controller 344, 544 toward the mass flow controller 344, 544. A variation PV of real flow rates PFR of the mass flow controller 344, 544 is measured at a mass flow meter 901 based on response characteristics GI of the flow rate of the mass flow controller 344, 544 with respect to the flow rate of the mass flow meter 901. And, by feedback of the variation PV of the real flow rate PFR of mass flow controller 344, 544, the flow rate control unit 900 adjusts a setup output SFR being sent to the mass flow controller 344, 544.

### Embodiment 1

Next, an explanation will be given of film fabrication examples using ALD method in regard to the case of an Al₂O₃ film being formed by use of TMA and O₃ gases and the case of a HfO₂ film being formed by using TEMAH and O₃ gases, each of which cases is one of semiconductor device fabrication processes.

The ALD (Atomic Layer Deposition) method, which is one of CVD (Chemical Vapor Deposition) methods, is a technique for alternately supplying, one at a time, two (or more) kinds of raw material gases used for the film fabrication onto a wafer 200 under specified film forming conditions (temperature, time, etc.) and for causing adsorption with a one atomic layer being as a unit to thereby perform the intended film formation by utilizing surface reaction.

More specifically, in the case of forming an Al₂O₃ (aluminum oxide) film as an example, it is possible to form a high-quality film at low temperatures of 250 to 450° C., by alternately supplying a vaporized gas of TMA (Al(CH₃)₃, trimethylaluminum) and an O₃ (ozone) gas as raw material gases.

On the other hand, in case a HfO₂ (hafnium oxide) film is formed, a vaporized gas of TEMAH (Hf[NCH₃C₂H₅]₄, tetrakis(N-ethyl-N-ethylamino) hafnium) and an O₃ gas are alternately supplied as raw material gases, thereby making it possible to form a high-quality film at low temperatures of 150 to 300° C.

In this way, with the ALD method, the film fabrication is performed by alternately supplying the plurality of kinds of raw material gases one at a time. And, film thickness control is done by control of a cycle number of such raw gas supply. For example, assuming that the film-forming rate is 1 Å/cycle, film fabrication processing is performed for 20 cycles in the case of forming a film with a thickness of 20 Å.

First, a procedure of forming the Al₂O₃ film will be explained.

A semiconductor silicon wafer 200 which is subjected to the film fabrication is charged to a boat 217, which is then conveyed for loading into the processing chamber 201. After the loading, the following four steps will be executed sequentially.

### (Step 1)

At a step 1, an O₃ gas is supplied to the processing chamber 201. More precisely, both the valve 243a of raw gas supply pipe 232a and the valve 243d of gas exhaust pipe 231 are opened to thereby supply the O₃ gas, which is from the raw gas supply pipe 232a and which is under flow rate control by the mass flow controller 241a, to the processing chamber 201 from gas feed holes of the confluence type gas supply nozzle 233 while at the same time exhausting it from the gas exhaust pipe 231.

When flowing the O₃ gas, the valve 243d is properly adjusted to maintain an internal pressure of the processing chamber 201 within an optimal range. The mass flow controller 241a is controlled to set the feed flow rate of O₃ gas at 1 to 10 slm and set a time for exposure of wafer 200 to O₃ gas at 2 to 120 seconds. At this time, the temperature of heater 207 is set in such a way that the temperature of wafer 200 falls within an optimal range of 250 to 450° C.

Simultaneously, an inactive gas may be flown from the inactive gas feed pipe 232c, 232f via the open/close valve 253, 257 that is driven to open. In this case, it is possible to prevent the O₃ gas from attempting to enter to the TMA side and the TEMAH side.

At this time, the gases being supplied to inside of the processing chamber 201 are only the O₃ gas and inactive gas, such as N₂, Ar and so on: TMA and TEMAH do not exist therein. Accordingly, the O₃ gas exhibits no vapor-phase reactions and experiences surface reaction (chemical adsorption) with surface portions of an undercoat film or the like on the wafer 200.

### (Step 2)

At a step 2, the valve 243a of raw gas supply pipe 232a is closed to stop the supply of the O₃ gas. While letting the valve 243d of gas exhaust pipe 231 be continuously opened, the processing chamber 201 is evacuated by the vacuum pump 246 to a pressure of 20 Pa or less, thereby removing the O₃ gas residing within the processing chamber 201 from the processing chamber 201. At this time, the inactive gas, such as N₂, Ar or else, may be supplied to the processing chamber 201 from a respective one of the raw gas supply pipes 232a, 232b and 232e. In this case, the effect of excluding the O₃ gas residing within the processing chamber 201 is further enhanced.

### (Step 3)

At a step 3, a vaporized gas of TMA is supplied to the processing chamber 201. More specifically, in the raw gas supply source 300, the valves 316, 326, 412, 352, 354 are closed while letting the valves 402, 346 be set in the open state (causing the valve 243d to be kept opened), thereby forcing an inactive gas to flow into the inactive gas feed pipe 312 from the inactive gas supply source 310. This inactive gas flows in the inactive gas feed pipe 312, bypass tube 400 and liquid raw material supply pipe 322 to reach the liquid raw material tank 340 while its flow rate is adjusted by the mass flow controller 314. The liquid raw material supply pipe 322 at the step 3 functions as an inactive gas feed pipe which supplies the inactive gas to the liquid raw material tank 340.

When the inactive gas is fed to the liquid raw material tank 340, the vaporized gas of TMA is allowed to flow into the raw gas supply pipe 232b. This vaporized gas of TMA flows in the raw gas supply pipe 232b while its flow rate and temperature are controlled by the mass flow controller 344. Then, this gas is exhausted from the gas exhaust pipe 231 while at the same time letting it be fed to the processing chamber 201 from the gas supply holes of the confluence type gas supply nozzle 233.

When flowing the vaporized gas of TMA, the valve 243d is properly adjusted to thereby maintain the internal pressure of the processing chamber 201 within an optimal range of 10 to 900 Pa. The mass flow controllers 314, 344 are controlled to set the feed flow rate of the inactive gas at 10 slm or less, with a time for feeding the evaporated gas of TMA being set at 1 to 4 seconds. Thereafter, for further adsorption, a time for exposure in an increased pressure atmosphere may be set at 0 to 4 seconds.

At the raw gas supply source 300, a detection result of the mass flow controller 344 is output to the controller 280, and the controller 280 monitors a vaporization amount of the TMA. Then, such monitoring result is fed back from the controller 280 to the mass flow controller 314, thereby to amend the supply flow rate of the inactive gas. For instance, when the vaporization amount of TMA decreases and becomes less than a fixed value, the feed flow rate of the inactive gas is increased.

At the step 3 also, the heater 207 is controlled to cause the temperature of wafer 200 to fall within an optimal range of 250 to 450° C. in a similar way to the O₃ gas supply event. By supply of the vaporized gas of TMA, the O₃ that has been chemically adsorbed to the surface of the wafer 200 and TMA perform surface reaction (chemical absorption) so that an Al₂O₃ film is formed on the wafer 200.

Simultaneously, an inactive gas may be flown from the inactive gas feed pipe 232d, 232f by opening the open/close valve 254, 257. In this case, it is possible to prevent the vaporized gas of TMA from entering to the O₃ side and the TEMAH side.

### (Step 4)

At a step 4, the valve 346 is closed and the valves 352, 354 are opened to stop the supply of the vaporized gas of TMA and, at the same time, the valve 243d is kept opened, thereby to perform vacuum evacuation of the processing chamber 201 for excluding the vaporized gas of TMA which resides within the processing chamber 201 and which has contributed to the film fabrication. At this time, an inactive gas, such as N₂, Ar or the like, may be supplied to the processing chamber 201 from a respective one of the raw gas supply pipes 232a, 232b and 232e. In this case, the effect of removing the vaporized gas of TMA that resides within the processing chamber 201 and that has contributed to the film fabrication is further enhanced.

Letting the steps 1-4 be a one cycle, this cycle is repeated for a plurality of times, thereby making it possible to form the Al₂O₃ film on the wafer 200 to a predetermined thickness. In this embodiment, the vaporized gas of TMA is allowed to flow after having evacuated the interior space of the processing chamber 201 for removal of the O₃ gas at the step 2 so that the both gases exhibit no reaction in mid course of approaching the wafer 200. Thus it is possible to permit the supplied vaporized gas of TMA to effectively react with only O₃ that is adsorbed to the wafer 200.

And, after having formed the above-noted Al₂O₃ film, TMA of the liquid raw material tank 320 is refilled to the liquid raw material tank 340. Precisely, in the raw gas supply source 300, the valves 402, 412, 346 are closed and the valves 316, 326, 352, 354 are set in the open state (letting the valve 243d be kept opened), thereby causing an inactive gas to flow from the inactive gas supply source 310 into the inactive gas feed pipe 312.

This inactive gas reaches the liquid raw material tank 320 from the inactive gas feed pipe 312 while its flow rate is adjusted by the mass flow controller 314, for ejecting TMA of the liquid raw material tank 320 into the liquid raw material supply pipe 322. This TMA flows in the liquid raw material supply pipe 322 and is sent by pressure to the liquid raw material tank 340 and then stored in the liquid raw material tank 340. Whereby, an amount of TMA required to form a following Al₂O₃ film(s) is refilled to the liquid raw material tank 340.

In this embodiment, a certain amount of TMA which is required for a one time of batch processing (i.e., the amount needed to form an Al₂O₃ film with a predetermined thickness) is refilled to the liquid raw material tank 340. This refilling or “resupply” will be repeatedly performed, once at a time, whenever an attempt is made to form an Al₂O₃ film with a predetermined thickness.

Subsequently, a procedure of forming a HfO₂ film will be described.

### (Step 5)

At a step 5, an O₃ gas is supplied to the processing chamber 201 in a similar way to the Al₂O₃ film formation event. More specifically, both the valve 243a of raw gas supply pipe 232a and the valve 243d of gas exhaust pipe 231 are opened to supply the O₃ gas, which is from the raw gas supply pipe 232a and which is under flow rate control by the mass flow controller 241a, to the processing chamber 201 from the gas supply holes of confluence type gas supply nozzle 233 while at the same time exhausting it from the gas exhaust pipe 231.

When flowing the O₃ gas, the valve 243d is properly adjusted to retain the internal pressure of the processing chamber 201 to say within an optimal range of 10 to 100 Pa. The supply flow amount of the O₃ gas that is controlled by the mass flow controller 241a is set at 1 to 10 slm; a time for exposure of wafer 200 to O₃ gas is set to 2 to 120 seconds. At this time, the temperature of the heater 207 is set so that the temperature of wafer 200 is kept within an optimal range of 150 to 300° C.

Simultaneously, an inactive gas may be flown from the inactive gas feed pipe 232f, 232c by opening the open/close valve 257, 253. In this case, it is possible to prevent the O₃ gas from entering to the TEMAH side and the TMA side.

At this time, the gases which are being fed to inside of the processing chamber 201 are only the O₃ gas and the inactive gas, such as N₂, Ar or the like: TEMAH and TMA do not exist. Accordingly, the O₃ gas exhibits no vapor-phase reactions and performs surface reaction (chemical adsorption) with a top surface of an undercoat film or the like on the wafer 200.

### (Step 6)

At a step 6, the valve 243a of the raw gas supply pipe 232a is closed to stop the supply of the O₃ gas. The valve 243d of gas exhaust pipe 231 is continuously opened for vacuum evacuation of the processing chamber 201 whereby the processing chamber 201 is evacuated by the vacuum pump 246 to a pressure of 20 Pa or less so that the O₃ gas residing within the processing chamber 201 is excluded from the processing chamber 201. At this time, an inactive gas, such as N₂, Ar or the like, may be supplied to the processing chamber 201 from a respective one of the raw gas supply pipes 232a, 232e and 232b. In this case, the effect of excluding the O₃ gas that resides within the processing chamber 201 is further enhanced.

### (Step 7)

At a step 7, a vaporized gas of TEMAH is supplied to the processing chamber 201. Precisely, in the raw gas supply source 500, the valves 516, 526, 612, 552, 554 are closed and the valves 602, 546 are set in the open state (the valve 243d is kept opened), thereby causing an inactive gas to flow into an inactive gas supply pipe 512 from an inactive gas supply source 510. This inactive gas flows in the inactive gas supply pipe 512, a bypass tube 600 and a liquid raw material supply pipe 522 to reach a liquid raw material tank 540 while its flow rate is adjusted by a mass flow controller 514. The liquid raw material supply pipe 522 at the step 7 functions as an inactive gas feed pipe which supplies the inactive gas to the liquid raw material tank 540.

When the inactive gas is supplied to the liquid raw material tank 540, the vaporized gas of TEMAH flows into the raw gas supply pipe 232e. Then, this vaporized TEMAH gas flows in the raw gas supply pipe 232e while its flow rate and temperature are controlled by the mass flow controller 544 and is supplied to the processing chamber 201 from the gas feed holes of the separation type gas supply nozzle 234 while at the same time being exhausted from the gas exhaust pipe 231.

When flowing the vaporized gas of TEMAH, the valve 243d is properly adjusted to maintain the internal pressure of the processing chamber 201 within an optimal range of 10 to 100 Pa. The mass flow controllers 514, 544 are controlled to set the supply flow rate of the inactive gas at 10 slm or less; a time for supplying the vaporized gas of TEMAH is set at 1 to 4 seconds. Thereafter, for further adsorption, a time for exposure in an increased pressure atmosphere may be set at 0 to 4 seconds.

At the raw gas supply source 500, a detection result of the mass flow controller 544 is output to the controller 280, and the controller 280 monitors the vaporization amount of TEMAH. Then, such monitoring result is fed back from the controller 280 to the mass flow controller 514, thereby amending the supply flow rate of the inactive gas. For example, when the vaporization amount of TEMAH decreases and becomes less than a fixed value, the feed flow rate of the inactive gas is increased.

At the step 7 also, the heater 207 is controlled to cause the temperature of the wafer 200 to fall within an optimal range of 150 to 300° C. in a similar way to the O₃ gas feed event. By the supply of the vaporized gas of TEMAH, the O₃ that has been chemically adsorbed to the surface of wafer 200 performs surface reaction (chemical absorption) with TEMAH whereby the intended HfO₂ film is formed on the wafer 200.

Simultaneously, an inactive gas may be flown from the inactive gas feed pipe 232d, 232c by opening the open/close valve 254, 253. In this case, it is possible to prevent the vaporized gas of TEMAH from entering to the O₃ side and the TMA side.

### (Step 8)

At a step 8, the valve 546 is closed and the valves 552, 554 are opened to thereby stop the supply of the vaporized gas of TEMAH; at the same time, the valve 243d is kept opened for vacuum evacuation of the processing chamber 201 to thereby exclude the vaporized TEMAH gas which resides within the processing chamber 201 and which has contributed to the film fabrication. At this time, an inactive gas, such as N₂, Ar or the like, may be supplied to the processing chamber 201 from a respective one of the raw gas supply pipes 232a, 232e and 232b. In this case, the effect of excluding the vaporized TEMAH gas that resides within the processing chamber 201 and that has contributed to the film fabrication is further enhanced.

Letting the above-noted steps 5-8 be a one cycle, this cycle is repeated for a plurality of times, thereby making it possible to form the intended HfO₂ film on wafer 200 to a predetermined thickness. In this embodiment, the vaporized TEMAH gas is allowed to flow after having evacuated the interior space of the processing chamber 201 and having removed the O₃ gas at the step 6 so that the both gases exhibit no reaction in mid course of approaching the wafer 200. Thus it is possible to permit the supplied vaporized TEMAH gas to effectively react with only O₃ which is presently adsorbed to the wafer 200.

After having formed the above-noted HfO₂ film, TEMAH of the liquid raw material tank 520 is resupplied to the liquid raw material tank 540. More specifically, in the raw gas supply source 500, the valves 602, 612, 546 are closed and the valves 516, 526, 552, 554 are set in the open state (letting the valve 243d be opened continuously), thereby causing an inactive gas to flow from the inactive gas supply source 510 into the inactive gas feed pipe 512. This inactive gas reaches the liquid raw material tank 520 from the inactive gas feed pipe 512 while its flow rate is adjusted by the mass flow controller 514, for ejecting TEMAH of the liquid raw material tank 520 to the liquid raw material supply pipe 522. This TEMAH flows in the liquid raw material supply pipe 322 and is sent to the liquid raw material tank 540 with a pressure applied thereto and then stored in the liquid raw material tank 540. Whereby, TEMAH that is required to form a following HfO₂ film is refilled to the liquid raw material tank 540.

In this embodiment, a specific amount of TEMAH which is required for one-time batch processing (i.e., the amount needed to form a HfO₂ film having a predetermined thickness) is refilled to the liquid raw material tank 540. This refilling will be repeatedly performed, once at a time, whenever a HfO₂ film with a predetermined thickness is formed.

As apparent from the foregoing, in the fabrication of the Al₂O₃ film, it is possible by converging together the raw gas supply pipes 232a, 232b within the processing chamber 201 to permit the vaporized gas of TMA and the O₃ gas to perform adsorption and reaction alternately even in the confluence type gas supply nozzle 233 to thereby deposit the intended Al₂O₃ film. It is also possible to solve a problem as to unwanted creation of an Al film which has the potential to become a foreign substance-producing source within the TMA nozzle in the case of supplying the vaporized TMA gas and the O₃ gas by separate nozzles. The Al₂O₃ film is better in adhesion property than Al film and is hardly peeled off; so, it seldom becomes the foreign substance production source.

Additionally, in the fabrication of the HfO₂ film, the O₃ gas is supplied from the confluence type gas supply nozzle 233 which is the form with the raw gas supply pipes 232a, 232b being combined together within the processing chamber 201 and being communicatively coupled to the single multi-hole nozzle 233a while supplying the vaporized gas of TEMAH from the separation type gas supply nozzle 234 with the raw gas supply pipe 232e alone being gas-flowably coupled to the single multi-hole nozzle 243a. Whereby, it is possible to avoid inactive gas purge for preventing backflow and inflow which become necessary in the case of using the confluence type gas supply nozzle when supplying TEMAH, thus making it possible to eliminate pressure increase within the nozzle due to the purge, which becomes problematic in the case of using the confluence type gas supply nozzle to supply TEMAH. In addition, it becomes possible to prevent production of contaminant particles otherwise occurring due to the reliquefaction of TEMAH as a result of such pressure increase (due to the fact that TEMAH is inherently low in vaporization pressure).

### Embodiment 2

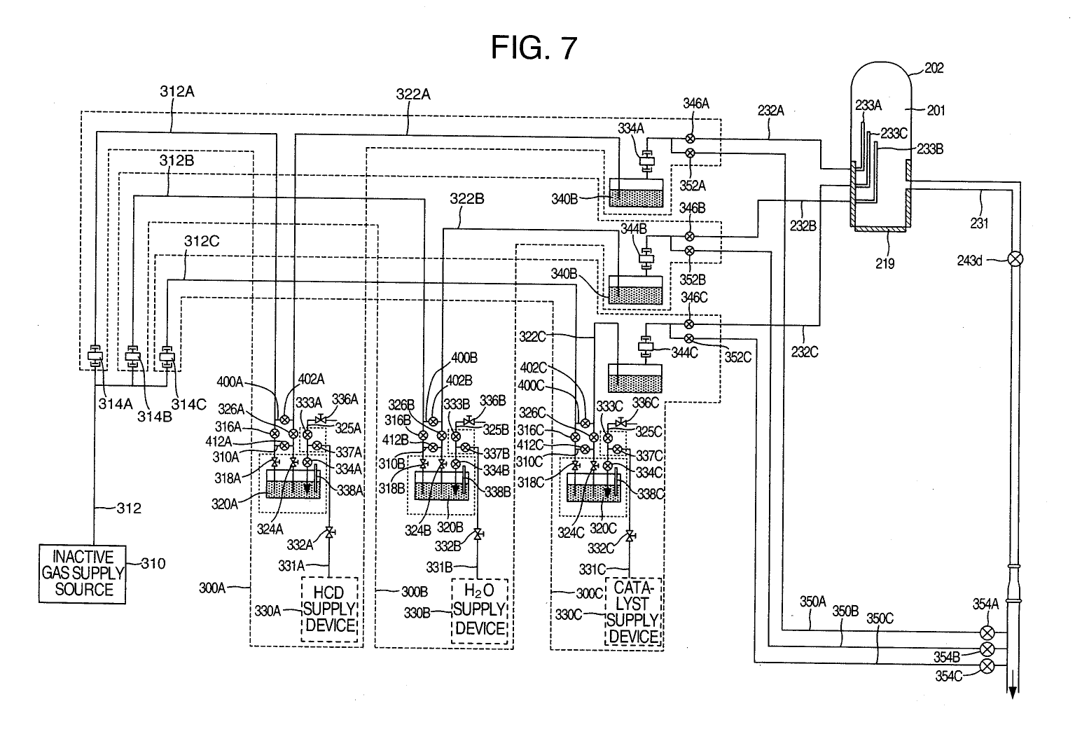

Although in the embodiment 1 there was described the case where the film formation is performed by ALD method by use of a single kind of liquid raw material for one kind of film seed, another case will be explained with reference to FIG. 7 below, which is for performing the film formation by ALD method by using three kinds of liquid raw materials. Note that members similar to those of FIG. 3 are added similar reference numerals, and detailed explanations are eliminated herein. Also note that each raw material gas supply source and its constituent members are designated by reference numerals with a character (A, B or C) being added thereto at a tail end of reference numeral, which is different from that of another raw material gas supply source and its constituent members, in order to distinguish it from the another raw material gas supply source and its constituent members.

For example, in the case of forming a SiO₂ film by using a catalytic agent, HCD (hexachlorodisilane, Si₂Cl₆), H₂O, catalyst (pyridine (C₅H₅N), etc.) are used as liquid raw materials, and vaporized gases of these three kinds of liquid raw materials are supplied alternately.

Examples of the liquid raw materials are as follows: HCD is used at a raw gas supply source 300A; H₂O is used at a raw gas supply source 300B; and, the catalyst is used at a raw gas supply source 300C. These HCD, H₂O and catalyst are liquids at room temperatures.

Note here that in the raw gas supply sources 300A, 300B and 300C also, each has a similar arrangement to the raw gas supply source 300, 500; in this embodiment, reference characters including three-digit numerals that are the same as those of the members of FIG. 3 are added to such respective members shown in FIG. 7, with their explanations being omitted herein.

In the case of performing film fabrication using a plurality of liquid raw materials as in this embodiment, raw gas supply sources are provided for the liquid raw materials, respectively.

In the above-stated embodiment, the feed rates of vaporized gases of the liquid raw materials under control of mass flow controllers 344, 544, 344A, 344B, 344C are monitored by the controller 280; so, even when clogging occurs due to reliquefaction of the vaporized gas of a liquid raw material, it is possible to detect this clog. And, an arrangement is employed for feedback of such monitoring result to mass flow controllers 314, 544, 314A, 314B, 314C so that it is possible by controlling the feed rate of an inactive gas to make stable the feed rates of the vaporized gases of the liquid raw materials.

Also note that in addition to liquid raw material tanks 320, 520, 320A, 320B, 320C, liquid raw material tanks 340, 540, 340A, 340B, 340C which are smaller in size than the above-noted tanks are provided so that it is possible to shrink the distance between a reservoir source of liquid raw material and the processing chamber 201 (i.e., the length of raw gas supply pipe 232b, 232e, 232A, 232B, 232C of vaporized gas of liquid raw material), thereby making it possible to lower the possibility of unwanted creation of particles due to reliquefaction of the vaporized gas(es).

Furthermore, since the illustrative embodiment apparatus has, in addition to the liquid raw material tanks 320, 520, 320A, 320B, 320C, the liquid raw material tanks 340, 540, 340A, 340B, 340C, which are smaller in size than the former tanks and each of which is capable of storing therein a liquid raw material required for one-time processing of a wafer 200, it is possible to minimize the direct reservoir amount of a liquid raw material needed for the processing of the wafer 200, thereby making it possible to reduce the dependency of a surface temperature of liquid raw material upon the remaining amount of such raw material.

As the embodiment apparatus has, in addition to the liquid raw material tanks 320, 520, 320A, 320B, 320C, the liquid raw material tanks 340, 540, 340A, 340B, 340C, each of which is less in size than the former tanks and is able to store therein the liquid raw material required for the one-time processing of a wafer 200, it becomes easier to control temperatures of the liquid raw materials.

As the apparatus has, in addition to the liquid raw material tanks 320, 520, 320A, 320B, 320C, the liquid raw material tanks 340, 540, 340A, 340B, 340C, each of which is less in size than the former tanks and is able to store the liquid raw material needed for the one-time processing of a wafer 200, the responsibility is improved to make the feedback control easier; thus, it is easy to control the feed rates of the gases being supplied to the processing chamber 201.

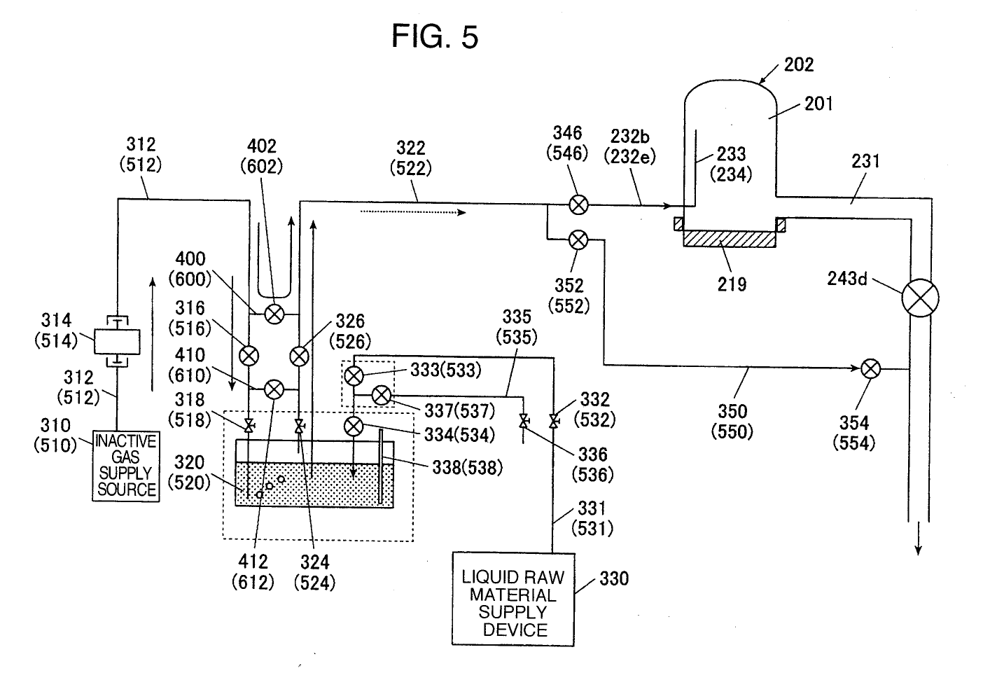

More specifically, an arrangement of FIG. 5 is supposable as a comparative example of the arrangements of FIG. 3 and FIG. 7 in accordance with the embodiments of the invention. In the arrangement of this comparative example, the liquid raw material tanks 340, 540, 340A, 340B, 340C and the mass flow controllers 344, 544, 344A, 344B, 344C are not provided while letting the fore end portions of liquid raw material supply pipes 322, 522, 322A, 322B, 322C be gas-flowably coupled to upper spaces of the liquid raw material tanks 320, 520, 320A, 320B, 320C. And, when causing an inactive gas to flow into inactive gas feed pipe 312, 512, 312A, 312B, 312C, this inactive gas reaches inside of the liquid raw material of the liquid raw material tank 320, 520, 320A, 320B, 320C, resulting in a vaporized gas of such liquid raw material reaching the processing chamber 201 through the liquid raw material supply pipe 322, 522, 322A, 322B, 322C and the raw gas supply pipe 232b, 232e, 232A, 232B, 232C.

In contrast to the comparative example, in this embodiment, the mass flow controller 344, 544, 344A, 344B, 344C exists in a section spanning from the liquid raw material tank 320, 520, 320A, 320B, 320C to the processing chamber 201 whereby the feed rate of a vaporized gas of each liquid raw material is monitored by the controller 280 so that it is possible to detect any clogging occurrable due to reliquefaction of the vaporized gas of liquid raw material. And, such monitoring result is arranged to be fed back to mass flow controller 314, 514, 314A, 314B, 314C. Thus it is possible to stabilize the feed rate of the vaporized gas of liquid raw material by control of the inactive gas feed rate.

Additionally, in contrast to the comparative example, this embodiment is such that the liquid raw material tank 340, 540, 340A, 340B, 340C exists in a section spanning from the liquid raw material tank 320, 520, 320A, 320B, 320C to the processing chamber 201 for causing the vaporized gas of the liquid raw material to be supplied therefrom to the processing chamber 201 so that the supply distance of such vaporized gas is shorter than that of the arrangement of the comparative example, thereby making it possible to lessen the risk of particle production due to reliquefaction of the vaporized gas. In addition, since the heatable mass flow controller 344, 544, 344A, 344B, 344C exists in a section spanning from the liquid raw material tank 340, 540, 340A, 340B, 340C to the processing chamber 201 for enabling heating of the vaporized gas of liquid raw material; so, it is possible to lower, without fail, the risk of particle production due to the reliquefaction of such vaporized gas.

Furthermore, in contrast to the arrangement of the comparative example, this embodiment is such that the liquid raw material tank 340, 540, 340A, 340B, 340C exists in the section spanning from the liquid raw material tank 320, 520, 320A, 320B, 320C to the processing chamber 201, wherein the liquid raw material tank 340, 540, 340A, 340B, 340C is smaller in size than the liquid raw material tank 320, 520, 320A, 320B, 320C and is capable of reserving therein the liquid raw material needed for one-time processing of a wafer 200; thus, it is possible to minimize the direct storage amount of the liquid raw material required for the processing of the wafer 200, thereby making it possible to reduce the dependency of a surface temperature of the liquid raw material upon the residual amount of such raw material.

With the features above, it is possible to stabilize the supply of the vaporized gases of liquid raw materials to the processing chamber 201.

It should be noted that while the methodology of gasifying a liquid raw material and supplying the resultant gaseous raw material to the processing chamber includes a technique using a vaporizer other than the bubbling technique, it is more effective to use the bubbling scheme rather than the vaporizer-based scheme as will be discussed below. In the case of the vaporizer, the vaporization amount of a raw material is determined depending on the performance of such vaporizer so that residual amount can take place if the vaporizer is made larger in order to increase the vaporization amount. Additionally, the enlargement of the vaporizer would result in deterioration of responsibility when performing the feedback control. Consequently, use of the bubbling scheme is more effective in view of the fact that this scheme is superior in responsibility and is usable at faster cycles.

Note that although in this embodiment the case of forming Al₂O₃ and HfO₂ films within the same processing chamber 201 has been explained as an example, a processing chamber aimed at fabrication of the HfO₂ film only is alternatively employable; in this case, it is possible to form the film by an arrangement having two nozzles, such as a separation type gas supply nozzle which supplies a vaporized gas of TEMAH and a separation type gas feed nozzle which supplies an O₃ gas.

Also note that the preferred form in accordance with this embodiment is not limited to the film kinds of Al₂O₃ and HfO₂ films and is also usable to form other kinds of films by evaporation of one or more liquid raw materials by the bubbling technique. For example, it is employable for fabrication of a TiN film which is formed by using, as its liquid raw material, titanium-based raw material such as titanium tetrachloride (TiCl₄) or the like, and formation of a low-temperature SiCN film using tetra-methyl-silane (4MS) or else as a liquid raw material thereof. At this time, the heating temperature of a raw material gas supply pipe is set at approximately 40° C. for both the titanium tetrachloride and the tetramethylsilane.

Further note that the preferred form in accordance with this embodiment is also usable for other kinds of films to be formed by evaporation of a plurality of liquid raw materials for a single kind of film. For example, it is applicable to fabrication of an ultralow-temperature SiO₂ film, which is formed by using HCD, H₂O and catalyzer as its liquid raw materials. At this time, the heating temperature of a raw material gas supply pipe that supplies at least the catalyst to the processing chamber is set at about 75° C.

While some preferred embodiments of this invention have been explained, there is provided a first substrate processing apparatus in accordance with one preferred embodiment of the invention, which apparatus comprises: a processing chamber for processing a substrate; a heating unit for heating the substrate; an evacuation unit for exhausting an atmospheric gas within said processing chamber; a couple of first and second liquid raw material tanks each storing therein a liquid raw material; a first carrier gas supply line for supplying a first carrier gas to the first liquid raw material tank; a first raw material supply line for receiving supply of the first carrier gas to said first liquid raw material tank and for sending by pressure the liquid raw material of said first liquid raw material tank to the second liquid raw material tank; a second carrier gas supply line for supplying a second carrier gas to said second liquid raw material tank; a second raw material supply line for receiving supply of the second carrier gas to said second liquid raw material tank and for supplying to said processing chamber a vaporized gas of the liquid raw material of said second liquid raw material tank; a flow rate control device for controlling a flow rate of the second carrier gas flowing in said second carrier gas supply line; a flow rate detector device for detecting a flow rate of the vaporized gas flowing in said second raw material supply line; and a feedback device for feedback of a detection result of said flow rate detector device to said flow rate control device, wherein said second liquid raw material tank is less in internal volume than said first liquid raw material tank, and wherein said second liquid raw material tank stores therein said liquid raw material needed for a one time of processing.

Preferably, in the first substrate processing apparatus, a second substrate processing apparatus is provided, which further comprises: a control unit; a liquid raw material supply device for supplying the liquid raw material to said first liquid raw material tank; and a residual amount detector device provided at said first liquid raw material tank, for monitoring a residual amount of the liquid raw material in said first liquid raw material tank, wherein said control unit is responsive to receipt of a detection result obtained by said residual amount detector device, for controlling said liquid raw material supply device in such a way as to supply the liquid raw material from said liquid raw material supply device to said first liquid raw material tank to thereby ensure that said liquid raw material is always stored in said first liquid raw material tank to have a prespecified amount.

Also preferably, in the first substrate processing apparatus, a third substrate processing apparatus is provided, wherein said control unit controls said heating unit in such a way as to heat a gas feed pile at a predetermined temperature, which pile is for interconnection between said processing chamber and said second liquid raw material tank.

And further, it is preferable that in the third substrate processing apparatus, a fourth substrate processing apparatus is provided, wherein a heating temperature of said gas feed pipe is different in accordance with the kind of said liquid raw material.

Furthermore, preferably, in the first substrate processing apparatus, a fifth substrate processing apparatus is provided, wherein said liquid raw material is any one of TEMAH, TMA, TiCl₄, 4MS, HCD, H₂O, and pyridine.

Furthermore, it is also preferable that in the first substrate processing apparatus, a sixth substrate processing apparatus is provided, wherein said second carrier gas supply line includes a bypass line for coupling together said first carrier gas supply line and said first raw material supply line, the first and second carrier gases are gases which are supplied from the same gas source, and said second carrier gas is supplied to said second liquid raw material tank by way of said bypass line without via said first liquid raw material tank.

It should be further understood by those skilled in the art that although the foregoing description has been made on embodiments of the invention, the invention is not limited thereto and various changes and modifications may be made without departing from the sprit of the invention and the scope of the appended claims.

1. A substrate processing apparatus comprising:
a processing chamber for processing a substrate;
a heating unit for heating the substrate;
an evacuation unit for removing atmospheric gases within said processing chamber;
first and second liquid raw material tanks each containing therein a liquid raw material;
a first carrier gas supply line for supplying a first carrier gas to the first liquid raw material tank;
a first raw material supply line for receiving supply of the first carrier gas to said first liquid raw material tank and for sending by pressure the liquid raw material of said first liquid raw material tank toward the second liquid raw material tank;
a second carrier gas supply line for supplying a second carrier gas to the second liquid raw material tank;
a second raw material supply line for receiving supply of the second carrier gas to said second liquid raw material tank and for supplying a vaporized gas of the liquid raw material of said second liquid raw material tank to said processing chamber;
a flow rate control device for controlling a flow rate of the second carrier gas flowing in said second carrier gas supply line;
a flow rate measure device for measuring a flow rate of the vaporized gas flowing in said second raw material supply line; and
a feedback device for feeding back a measure result of said flow rate measure device to said flow rate control device, wherein
said second liquid raw material tank is smaller in internal volume than said first liquid raw material tank and wherein said second liquid raw material tank reserves said liquid raw material required for a one time of processing.

2. A substrate processing apparatus according to claim 1, further comprising:
a control unit;
a liquid raw material supply device for supplying said liquid raw material to said first liquid raw material tank; and
a residual amount measure device provided at said first liquid raw material tank, for monitoring a residual amount of said liquid raw material in said first liquid raw material tank, wherein
said control device controls said liquid raw material supply device based on the measure result obtained by said residual amount measure device to thereby supply the liquid raw material from said liquid raw material supply device to said first liquid raw material tank in such a way that a predetermined amount of said liquid raw material is stored in said first liquid raw material tank at all times.

3. A substrate processing apparatus according to claim 1, wherein said control unit controls said heating unit in such a way as to heat at a predetermined temperature a gas supply pipe which couples together said processing chamber and said second liquid raw material tank.

4. A substrate processing apparatus according to claim 3, wherein a heating temperature of said gas supply pipe is different in accordance with the kind of said liquid raw material.

5. A substrate processing apparatus according to claim 1, wherein said liquid raw material is any one of TEMAH, TMA, TiCl₄, 4MS, HCD, H₂O and pyridine.

6. A substrate processing apparatus according to claim 1, wherein said second carrier gas supply line includes a bypass line which couples together said first carrier gas supply line and said first raw material supply line,
said first carrier gas and said second carrier gas are gases fed from the same gas source, and
said second carrier gas is supplied to said second liquid raw material tank by way of said bypass line without via said first liquid raw material tank.
